(19) United States
(12) Patent Application Publication
(10) Pub. No.: US 2016/0068258 A1
(43) Pub. Date: Mar. 10, 2016

(54) Aircraft with C-Shaped Carrier Surfaces and Movable Top Surfaces

(71) Applicant: Airbus Defence and Space GmbH, Ottobrunn (DE)

(72) Inventors: Klaus Seywald, Munchen (DE); Andreas Wildschek, Riemerling (DE)

(21) Appl. No.: 14/845,909

(22) Filed: Sep. 4, 2015

(30) Foreign Application Priority Data
Sep. 5, 2014 (DE) 10 2014 112 827.3

(51) Int. Cl. B64C 23/06

(52) U.S. Cl. CPC B64C 23/065

(57) ABSTRACT

An aircraft with C-shaped carrier surfaces wherein an axis of rotation of top surfaces is arranged in the respective aerodynamic center of the top surfaces, furthermore that each top surface can be adjusted by an adjustment device that can be controlled by a control device, wherein an angle of attack of the top surfaces can be adjusted that is optimal for a minimal induced resistance based on flight state parameters. This arrangement minimizes the adjusting moment during the adjusting of the top surfaces and is independent of the angle of attack of the top surface.

### CROSS-REFERENCE TO RELATED APPLICATIONS

This application claims priority to and benefit of German Patent Application No. 10 2014 112 827.3 filed 5 Sep. 2014, the contents of which are incorporated herein by reference in their entirety.

### BACKGROUND

1. Field

The invention relates to an aircraft with C-shaped carriers comprising a lower main carrier surface, a winglet surface extending upward on its end, and on the end of which winglet surface an inwardly extending top surface is fastened, wherein the top surface can pivot about a central axis.

2. Brief Discussion of Related Art

Such aircraft are known from U.S. Des. 363,696. In it the top surfaces are rigidly attached to the winglets. Such carrier surfaces have a reduced induced resistance, in particular when the top surfaces produce a slight drift. The disadvantage here is that the induced resistance is dependent on the flight state (rising flight, cruising flight, dropping flight, center of gravity, weight, distribution of weight).

Furthermore, it is known from the publication “Aeroelastic investigations of a self-trimming non-planar wing” by Ulrich Kling et al. dated 2013 to construct the top surfaces of C-shaped carrier surfaces so that they can pivot about a transverse axis in order to use them as trimming surfaces and to stabilize and/or maintain the longitudinal flight position with it and reduce or entirely eliminate other trim surfaces such as horizontal tails or Vee-tails.

### SUMMARY

Starting from the above, the invention is based on the problem of making an aircraft available with C-shaped carrier surfaces comprising a lower main carrier surface, a winglet surface extending upward on its end, on the end of which winglet surface an inwardly extending top surface is fastened, wherein the top surface is pivotable, and wherein the induced resistance is also minimized upon a change of the flight state.

This problem is solved in accordance with the invention in that an axis of rotation of the top surfaces is arranged in the aerodynamic center of each top surface, and furthermore each top surface can be adjusted by an adjustment device, wherein the two adjustment devices can be controlled at the same time by a control device, and wherein an angle of attack of the top surfaces can be adjusted which is optimal for a minimal induced resistance.

The aerodynamic center of a profile (or neutral point) is the fixed point with a constant rotation point in the area of moderate angles of attack. It is located approximately on the profile chord at 25% of the profile depth. In practice, in the framework of the invention the axis of rotation can deviate by ±2% (relative to the profile chord of the top surface) from the aerodynamic center.

The adjusting moment of the adjusting of the top surface is minimized and is independent of the angle of attack of the top surface by the arrangement of the axes of rotation of the top surfaces in the aerodynamic center of the particular top surface. As a result, the adjustment devices can be constructed compactly, which leads to minimal loads and the lowest possible weight of the support. As a result of the common adjustment of the two top surfaces by a common control device on the basis of detected flight state parameters, the angle of attack of the two top surfaces which is optimal for a minimal induced resistance can be adjusted for every flight state considered.

The optimal angle of attack is determined in advance by calculations and/or tests based on the flight state parameters based on complex calculations, and is stored in a software-based table. Flight state parameters are in particular flight speed, flight position, angle of attack, center of gravity and flap position.

According to an advantageous further development of the invention an adjustment device is constructed as a redundantly operating, double spindle drive. In this manner, the functionality of the device is ensured even in case of a failure of a spindle drive, as a result of which certifications such as, for example, according to EASA CS-25 are achieved. A spindle drive is normally relatively slow but its construction can be readily improved.

According to an advantageous further development of the invention the adjustment device is hydraulically constructed. This construction makes possible a very compact construction and a rapid mobility of the top surfaces.

According to an advantageous further development of the invention, each adjustment device is constructed from a combination of a spindle drive for slow adjusting movements and of a hydraulic cylinder for rapid adjusting movements. The control device is preferably constructed to individually control the two adjustment devices, wherein additional adjusting signals for the two top surfaces for the controlling of the aircraft can be inputted. This construction makes it possible to additionally use the top surfaces for minimizing the induced resistance and to therefore create the possibility of reducing or entirely eliminating the normally present control surfaces.

The control device is preferably constructed in such a manner to minimize the resistance to emit positioning signals for a certain inclination of the top surfaces to the spindle drives and to emit positioning signals for control to the hydraulic cylinders. The spindle drives then bring about the only similar adaptation of the angle of inclination of the top surfaces whereas the hydraulic cylinders bring about the control of the aircraft equally or oppositely to one another.

An alternative construction provides that at least one additional, movable control surface is arranged along at least one part of the front or back edges of the top surfaces. This construction makes possible, like the above-described one, the simultaneous utilization of the top surfaces for minimizing resistance and as a control possibility, wherein the inclination of the top surfaces serves to minimize the resistance whereas the at least one control surface serves to control the aircraft. If needed, even several control surfaces can be arranged adjacent to each other or they can extend over the entire length of the top surface or only along a part of it.

According to an advantageous further development of the invention, the pivot range of the top surface is −15° to +10°. A pivot range from −10° to +5° is especially preferred.

Other advantages, features and details result from the following description in which at least one exemplary embodiment is described in detail with reference made to the drawings. Parts which are the same, similar and/or functionally equal are provided with the same reference numerals.

### BRIEF DESCRIPTION OF THE DRAWINGS

In the drawings:

FIG. 1 shows a schematic view of an aircraft with C-shaped carrier surfaces from the front;

FIG. 2 shows a schematic top view onto a C-shaped carrier surface;

FIG. 3 shows a schematic side view of a C-shaped carrier surface; and

FIG. 4 shows a block wiring diagram of the components.

### DETAILED DESCRIPTION

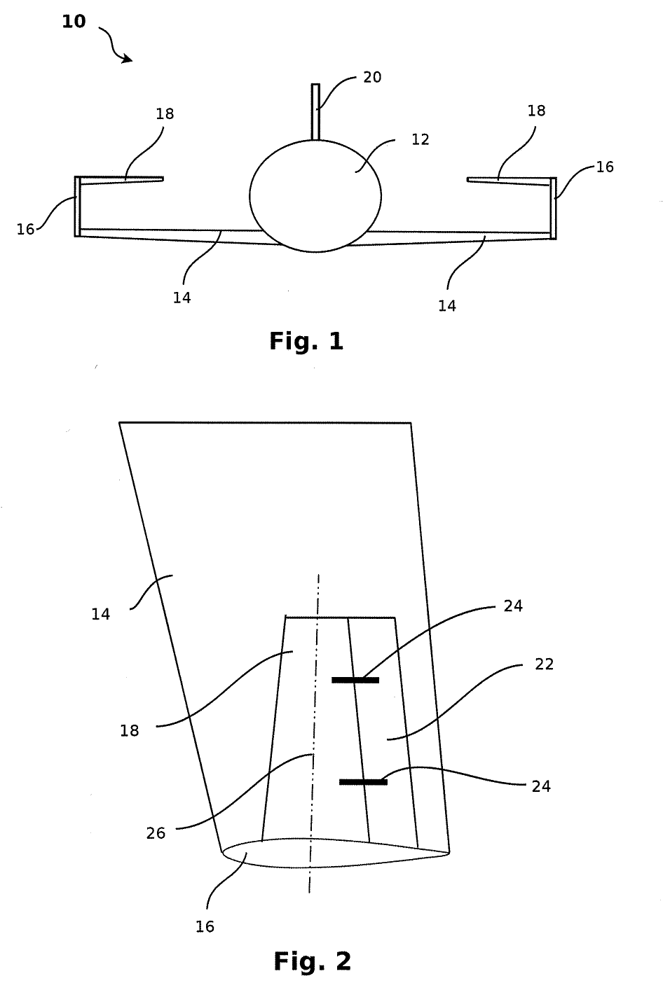

FIG. 1 shows a schematic view of an aircraft 10 with a body 12 and C-shaped main carrier surfaces 14 from the front, on whose ends winglets 16 are arranged that are substantially oriented vertically upward and on whose upper ends top surfaces 18 are arranged that extend inward toward the fuselage 12. A side rudder 20 is also shown. All surfaces 14, 16, 18, 20 are shown purely schematically horizontally and vertically. Actually, the main carrier surfaces 14 and the top surfaces 18 can have an inclination of a few degrees relative to the horizontal. Also, the winglets 16 do not have to run obligatorily vertically but can be inclined to the vertical. A bend between the wing and the winglet and between the winglet and the top surface is not obligatorily necessary but the transition can also be rounded.

FIG. 2 shows a main carrier surface 14 from above with a winglet 16 and a top surface 18 whose rear edge comprises a control surface 22. This control surface 22 is adjusted by two schematically shown flap adjustment devices 24.

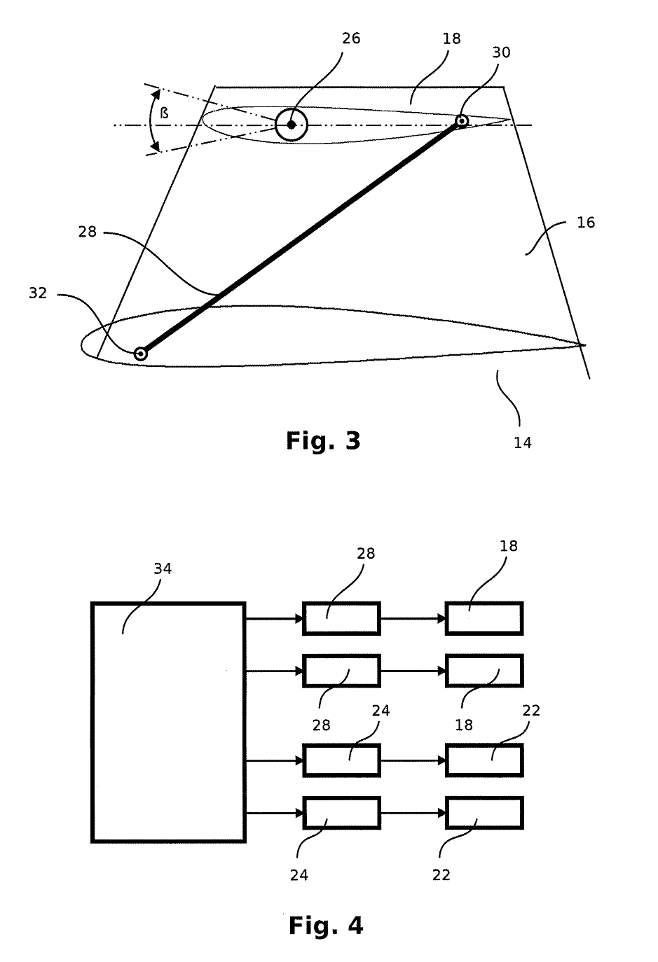

As FIG. 3 shows, the top surface 18 produces drift in order to minimize the induced resistance and therefore counteracts to a certain degree (a few percentages) the lift produced by the main carrier surfaces 14.

The top surface 18 can pivot about an axis of rotation 26, preferably with a pivot range β from −15° to +10° (FIG. 3). The axis of rotation 26 lies in the aerodynamic center of the top surface, therefore, approximately at 25% of the profile chord viewed from the front.

The top surface 18 is activated by an adjustment device 28 preferably articulated in the rear area onto the top surface 18 and in the area of the main carrier surface 14 onto an upper articulation position 30. A lower articulation position 32 of the adjustment device 28 is preferably arranged in the front area of the winglet 16 or of the main carrier surface 14 in order that the center of gravity of the adjustment device 28 can be moved to the front. In order to achieve a better transfer of force the adjustment device 28 can alternatively also be aligned largely vertically so that so that the lower articulation position 32 of the adjustment device 28 lies approximately under the upper articulation position 30. The connection of the adjustment device 28 to the top surface 18 can take place either through a curved slot in the winglet 16 (which is covered by shields) or by a lever arm arranged inside the winglet 16 between the two (not shown) support positions of the axis of rotation 26.

The adjustment device 28 is preferably constructed as a redundantly acting double spindle drive so that if one device fails the second spindle drive can carry out the adjustment. Alternatively, the adjustment device 28 can also be constructed differently, in particular for a rapid adjustment as a hydraulic device. In such a case preferably at least two hydraulic cylinders arranged in parallel would be provided that are arranged either one behind the other or adjacent to one another.

Alternatively to the one control surface shown in FIG. 2, even several carrier surfaces can be arranged adjacent to each other.

FIG. 4 shows a block wiring diagram of the components, including a control device 34 which controls the two adjustment devices 28 for the two top surfaces 18. The control device 34 comprises several inputs (not shown) for flight state parameters, a calculating unit in which an angle of attack for the two top surfaces 18 is determined using the flight state parameters on the basis of stored computer algorithms and/or tables which angle of attack is transmitted to the two adjustment devices 28. The latter adjust the two top surfaces 18 to the calculated angle of attack β.

For the embodiment shown in FIG. 2 with additional carrier surfaces 22 the flap adjustment devices 24 are appropriately controlled by the control device 34, in particular in order to bring about pitching or rolling movements of the aircraft 10.

Even though the invention was illustrated and explained in detail by preferred exemplary embodiments, the invention is not limited by the disclosed examples and other variations can be derived by a person skilled in the art without leaving the protective scope of the invention. It is therefore clear that there is a plurality of possibilities of variation. It is also clear that embodiments cited by way of example are really only examples that are not to be understood in any manner as a limitation, for example, of the protective scope, of the possibilities of use or of the configuration of the invention, but rather the previous description and a description of the figures put a person skilled in the art in the position to concretely realize the exemplary embodiments, wherein the person skilled in the art in possession of the knowledge of the disclosed inventive concept can carry out many changes, for example, regarding the function or the arrangement of individual elements cited in the exemplary embodiment without leaving the protective scope defined by the claims and their legal correspondences such as, for example, extensive explanations in the specification.

### LIST OF REFERENCE NUMERALS

10 aircraft;
12 fuselage;
14 main carrier surfaces;
16 winglets;
18 top surfaces;
20 side rudder;
22 control surface;
24 flap adjustment devices;
26 axis of rotation;
28 adjustment device;
30 upper articulation position;
32 lower articulation position; and
34 control device.

1. An aircraft with C-shaped carriers comprising a lower main carrier surface, a winglet surface extending upward on its end, and on the end of which winglet surface an inwardly extending top surface is fastened, wherein an axis of rotation of the top surfaces is arranged in the respective aerodynamic center of the top surfaces, furthermore, that each top surface is adjustable by an adjustment device, wherein the two adjustment devices are controllable in the same manner by a control device, and wherein an angle of attack of the top surfaces is adjustable which is optimal for a minimal induced resistance.

2. The aircraft according to claim 1, wherein the adjustment device is constructed as a redundantly operating, double spindle drive.

3. The aircraft according to claim 1, wherein the adjustment device is hydraulically constructed.

4. The aircraft according to claim 1, wherein each adjustment device is constructed from a combination of a spindle drive for slow adjusting movements and of a hydraulic cylinder for rapid adjusting movements.

5. The aircraft according to claim 4, wherein the control device is constructed to individually control the two adjustment devices, and additional adjusting signals for the two top surfaces for the controlling of the aircraft are enabled to be inputted.

6. The aircraft according to claim 5, wherein the control device is constructed in such a manner to minimize the resistance to emit positioning signals for a certain inclination of the top surfaces to the spindle drives and to emit positioning signals for control to the hydraulic cylinders.

7. The aircraft according to claim 1, wherein at least one additional, movable control surface is arranged along at least one part of the front or back edges of the top surfaces.

8. The aircraft according to claim 1, wherein the pivot range of the top surface is −15° to +10°.

9. The aircraft according to claim 1, wherein the pivot range of the top surface is −10° to +5°.
